(19) United States
(12) Patent Application Publication
(10) Pub. No.: US 2009/0327656 A1
(43) Pub. Date: Dec. 31, 2009

(54) EFFICIENCY-BASED DETERMINATION OF OPERATIONAL CHARACTERISTICS

(76) Inventors: Dan Baum, Haifa (IL); Dany Rybnikov, Zichron Yakov (IL); Erfraim Rotem, Haifa (IL); Ronny Komer, Haifa (IL)

Correspondence Address: KACVINSKY LLC;C/O INTELLEVATE, P.O. BOX 52050, MINNEAPOLIS, MN, 55402, US

(21) Appl. No.: 12/122,221

(22) Filed: May 16, 2008

(51) Int. Cl. G06F 9/318

(52) U.S. Cl. 712/43; 712/E09.035

(57) ABSTRACT

Techniques are disclosed involving techniques that may dynamically adjust processor (e.g., CPU) performance. For instance, an apparatus includes a counter, an efficiency determination module, and a management module. The counter determines a number of event occurrences, wherein each of the event occurrences involves a processor component (e.g., a processor core) awaiting a response from a device. The efficiency determination module determines an efficiency metric based on the number of event occurrences. The management module establishes one or more operational characteristics for the processor component that correspond to the efficiency metric. Other embodiments are described and claimed.

### BACKGROUND

Reducing the energy and power consumption of processors is becoming increasingly important in many situations. For instance, such power and energy reductions can reduce overall costs for the customer. Additionally, such power and energy reductions can increase the battery life of mobile products.

Processors can operate according to various active mode states. Each of these states may provide a certain level of performance (e.g., speed). However, for these states, power consumption increases with processor performance. In addition, processors can operate in a sleep mode. In this mode, one or more components may be turned off to conserve power consumption.

Processor performance is often limited by external devices or components such as memory or input/output (IO) devices. For example, when a processor is waiting for an external device, it can either go into the sleep mode or remain active. More particularly, when an expected delay is long (such as when waiting for a response from a hard disk drive), the processor may enter the sleep mode. However, for short expected delays, the processor will typically remain in an active mode while waiting for a response.

In many operational scenarios, most of such waiting times are considered short. Therefore, during operation, it is common for the processor to spend most of its waiting times in the active mode. During such times, processors typically perform in a power inefficient manner.

### BRIEF DESCRIPTION OF THE DRAWINGS

FIG. 1 illustrates one embodiment of a first apparatus.

FIG. 2 illustrates one embodiment of a second apparatus.

FIG. 3 illustrates one embodiment of an exemplary logic flow.

FIG. 4 illustrates one embodiment of a performance graph.

FIG. 5 illustrates one embodiment of an exemplary system.

### DETAILED DESCRIPTION

Various embodiments provide techniques that may dynamically adjust processor performance. For example, such techniques may identify processor efficiency and may adjust the processor's performance (e.g., its speed). Such adjustments may involve changing the processor's operational state (e.g., its P-state). For example, upon detecting that a processor is memory bounded or waiting for another device (such as a graphics card), techniques may adjust the processor's operation so that it runs slower. As a result, energy is conserved. In contrast, upon detecting that the processor is no longer constrained by such limitations, the processor may re-invest the saved energy in providing enhanced performance (e.g. faster operation) by operating at a higher frequency. Such adjustments to processor operation may involve various techniques. Exemplary techniques include toggling the processor's clock signal on and off, and/or changing the processor's operational frequency with or without voltage change.

In embodiments, such techniques may be implemented within the processor. However, in further embodiments, implementations may involve external software and/or external hardware.

Embodiments may include one or more elements. An element may comprise any structure arranged to perform certain operations. Each element may be implemented as hardware, software, or any combination thereof, as desired for a given set of design parameters or performance constraints. Although embodiments may be described with particular elements in certain arrangements by way of example, embodiments may include other combinations of elements in alternate arrangements.

It is worthy to note that any reference to “one embodiment” or “an embodiment” means that a particular feature, structure, or characteristic described in connection with the embodiment is included in at least one embodiment. The appearances of the phrases “in one embodiment” and “in an embodiment” in various places in the specification are not necessarily all referring to the same embodiment.

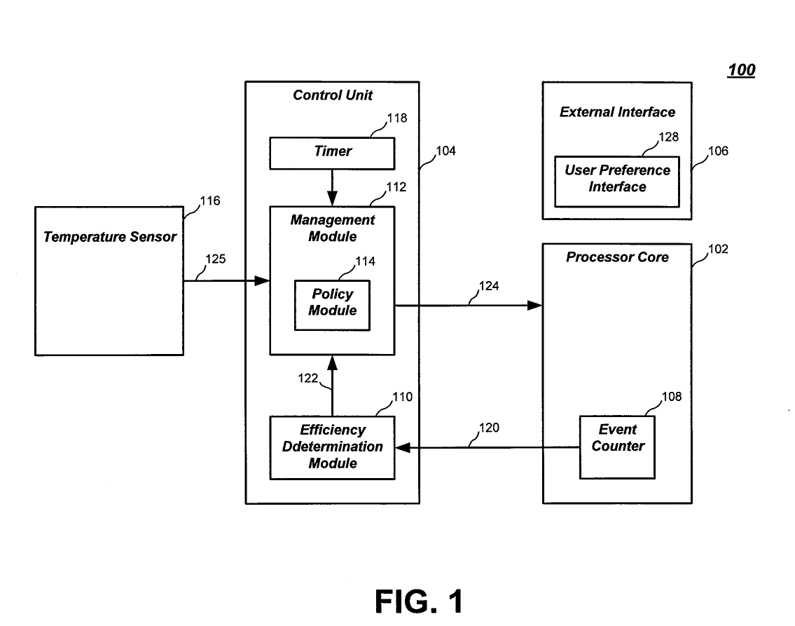

FIG. 1 illustrates an exemplary apparatus 100 that may adjust operation based on efficiency determinations. Apparatus 100 may include various elements. For instance, FIG. 1 shows that apparatus 100 may include a processor core 102, a control unit 104, and an external interface 106. Also, apparatus 100 may include a temperature sensor 116. The elements of apparatus 100 may be implemented within a processor. Exemplary processors include (but are not limited to) central processing units (CPUs), graphics processors, and digital signal processors (DSPs).

Processor core 102 performs operations that produce specific outputs for a given set of inputs. Such inputs may be instructions associated with an instruction set. In embodiments, processor core 102 may be implemented with a plurality of logic gates and may be designed for general-purpose functions.

Processor core 102 may operate in various active mode states. For example, apparatus 100 may operate in different performance states (also called “P-states”). Each of these P-states has a corresponding operational frequency and voltage level. In particular, P-states having higher voltages and frequencies provide greater performance (e.g., greater speed). However, as indicated above, such increases in performance require greater power consumption.

External interface 106 may provide for the exchange of information with various external devices through one or more interconnections. Such devices may include (but are not limited to) memory (e.g., dynamic random access memory (DRAM)), graphics chips, I/O devices, and/or disk drives. Exemplary interconnections include one or more bus interfaces and/or one or more point-to-point interfaces. Embodiments, however, are not limited to these examples. Accordingly, external interface 106 may include control logic and electronics (e.g., transceivers) to facilitate such exchanges of information.

External interface 106 may include a user preference interface 128. The user preference interface 128 may operate as an interface to display information for a user or operator using various graphic user interface (GUI) elements. The user preference interface 128 may also operate to receive information from a user, such as user commands, user preferences, and so forth. In particular, the user preference interface 128 may receive control directives and preference information for the efficiency determination module 110, management module 112, and policy module 114, among other elements of apparatus 100.

In embodiments, processor core 102 may generate data regarding particular operations. This data may be accumulated by one or more counters. For instance, FIG. 1 shows processor core 102 having an event counter 108 that counts occurrences of particular events. Such events may include ones in which processor core 102 waits for responses from external devices. Examples of such events include communications with external devices, such as communications with external memory, I/O communications, communications with graphics processors/cards, and/or communications with hard drives. Embodiments, however, are not limited to these examples.

For instance, counters 108 may count one or more particular types of memory accesses. Examples of such accesses include (but are not limited to) long duration accesses, accesses that are not speculative, and/or accesses that block execution of other instructions/

Event counter 108 includes control logic to identify the occurrence of such events. This control logic may be implemented in any combination of hardware, software, and/or firmware. Event identification may occur based on the existence of corresponding interface (e.g., bus) signals and/or commands. Also, event identification may occur through from the execution of software instruction(s) associated with external device access, as well as through the existence of busy loops waiting for data. Embodiments, however, are not limited to these examples.

More particularly, event counter 108 may generate a tally of such events that have occurred in a preceding (e.g., an immediately preceding) time interval. Thus, event counter 108 accumulates event tallies that occur within a sliding time window. Various time interval durations may be employed. An exemplary duration is 1 millisecond. As shown in FIG. 1, this tally is provided to control unit 104 as a count 120. In embodiments, count 120 may be provided to control unit 104 through parallel (e.g., 16-bit) signal lines. However, other techniques may alternatively be employed.

Control unit 104 establishes performance characteristics for processor core 102. These established performance characteristics are based on an assessed operational efficiency of processor core 102. As shown in FIG. 1, control unit 104 includes an efficiency determination module 110, a management module 112, and a timer 118.

Efficiency determination module 110 determines an operating efficiency of processor core 102 based on its performance. For instance, efficiency determination module 110 may determine an efficiency metric 122 from count 120.

As described above, count 120 indicates a number of events that have occurred over a time interval (e.g., within a sliding time window). Such events may be ones in which processor core 102 waits for responses from external devices. Thus, count 120 indicates a lower efficiency when it has a larger magnitude, and indicates a greater efficiency when it has a smaller magnitude. Accordingly, efficiency determination module 110 may determine efficiency metric 122 such that it is inversely proportional to count 120.

As an addition or alternative to deriving efficiency metric 122 from count 120, the efficiency determination module 110 may determine efficiency metric 122 using various other techniques. In one embodiment, for example, efficiency determination module 110 may determine efficiency metric 122 using a trial and error technique. For example, a range of values may be implemented for efficiency metric 122 until a desired measured output has been achieved. The measured output may be in terms of a power consumption rate, average processor utilization, application response times, and so forth. In one embodiment, for example, efficiency determination module 110 may determine efficiency metric 122 by monitoring and recording various characteristics of an application while previously executed by processor core 102 (or another processor core) to create an application history. Efficiency determination module 110 may use the application history and a prediction algorithm to predict a value for efficiency metric 122 for use when the application is actually executed by processor core 102. Other techniques and processor core heuristics may be used to generate efficiency metric 122, and the embodiments are not limited in this context. Management module 112 establishes operational characteristics of processor core 102. This may comprise establishing operating frequencies and/or voltages for processor core 102. Such operational characteristics of processor core 102 may be established based on efficiency metric 122. Accordingly, FIG. 1 shows management module 112 receiving efficiency metric 122 from efficiency determination module 110.

Upon receipt of efficiency metric 122, management module 112 may select corresponding operational characteristics. Based on this selection, management module 112 may send a directive 124 to processor core 102. This directive instructs processor core 102 to operate according to the selected characteristics. As stated above, such characteristics may include a particular operating frequency and/or voltage (e.g., a particular P-state). Alternatively or additionally, such characteristics may include clock toggling settings for processor core 102.

This selection of operating characteristics for processor core 102 may be in accordance with a scheme that maps ranges of efficiency metric 122 to particular operating characteristic(s). As described above, such operating characteristic(s) may include an operating frequency and/or voltage (e.g., a P-state). Alternatively or additionally, such characteristics may include clock toggling settings for processor core 102.

This mapping between ranges of efficiency metric 122 and operating characteristic(s) may be provided by a policy module 114. As shown in FIG. 1, policy module 114 may be included in management module 112. In embodiments, policy module 114 may comprise a storage medium (e.g., memory) that contains these correspondences. However, other implementation techniques may be employed.

Assigning operating characteristics may come at some cost. For example changing operating frequency and voltage involves locking PLL and changing the voltage which may take some time. Frequently changing the operating characteristic may result in net lost and not gain. Timer 118 can be used to limit operating characteristics change to not more then pre-defined transitions/second.

As described above, external interface 106 for apparatus 100 may include a user preference interface 128. The user preference interface 128 allows a user or operator to add preferences for the algorithm Examples of such policies may include increasing energy savings, providing enhanced performance, and so forth.

As described above, apparatus 100 may include a temperature sensor 116. This sensor determines a current operating temperature of apparatus 100. Temperature sensor 116 may be implemented in various ways. For example, temperature sensor 116 may include a thermistor-based circuit.

As shown in FIG. 1, temperature sensor 116 may provide management module 112 with a signal 125 that indicates the current operational temperature. Based on this signal, management module 112 may determine the amount of additional power consumption that apparatus 100 may handle without causing a maximum temperature to be exceeded. This additional power consumption is referred to as “headroom”.

Management module 112 may determine this additional headroom in various ways. In exemplary implementations, management module 112 may include a lookup table containing pre-stored headroom values for particular temperature values (or ranges of values). In further exemplary implementations, management module 112 may calculate headroom in real time.

Based on this headroom, management module 112 may determine limits for operational characteristic(s), such as a maximum operating frequency and/or voltage (e.g., a P-state), as well as clock toggling limits. Accordingly, in determining such characteristic(s) for directive 124, policy module 114, may modify operational characteristic(s) determined from efficiency metric 122 such that they do not cause the determined headroom to be exceeded.

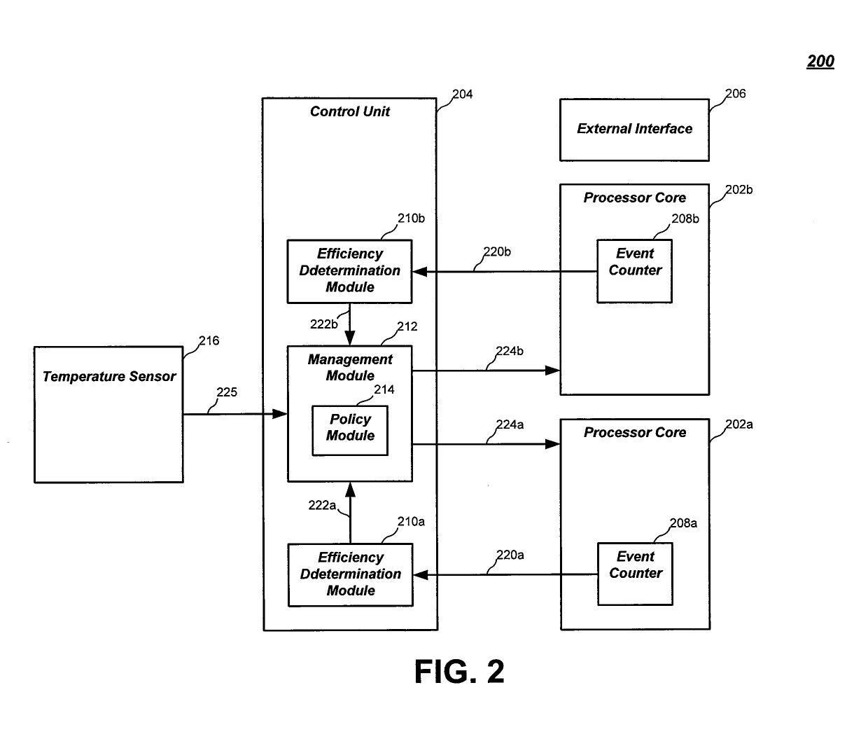

FIG. 2 illustrates a further apparatus 200 that may adjust operation based on efficiency determinations. Apparatus 200 may include various elements. For instance, FIG. 2 shows that apparatus 200 may include multiple processor cores 202a-b, a control unit 204, and an external interface 206. Also, apparatus 100 may include a temperature sensor 216. The elements of apparatus 200 may be implemented within a processor (e.g., a CPU, a graphics processor, a DSP, etc.). Embodiments, however, are not limited to such implementations.

Each of processor cores 202a-b performs operations that produce specific outputs for a given set of inputs. Such inputs may be instructions associated with an instruction set. In embodiments, each of processor cores 202a-b may be implemented with a plurality of logic gates and may be designed for general-purpose functions. In addition, each of processor cores 202a-b may operate in various active mode states (e.g., in different P-states).

External interface 206 may provide for the exchange of information with various devices through one or more interconnections (bus interface(s) and/or point-to-point interface(s)). As described above, such devices may include (but are not limited to) memory (e.g., DRAM), graphics chips, I/O devices, and/or disk drives. External interface 206 may be implemented in the manner of external interface 106, as described above with reference to FIG. 1.

In embodiments, each of processor cores 202a-b may generate data regarding particular operations. This data may be accumulated by one or more counters. For instance, FIG. 2 shows processor core 202a including an event counter 208a, and processor core 202b including an event counter 208b. Event counter 208a counts occurrences of particular events within processor core 202a. Similarly, event counter 208b counts occurrences of particular events within processor core 202b.

As described above with reference to FIG. 1, such events may include ones in which the corresponding processor core 202 waits for responses from external devices. Examples of such events include communications with external devices, such as communications with external memory, I/O communications, communications with graphics processors/cards, and/or communications with hard drives. Embodiments, however, are not limited to these examples.

For instance, counters 208a-b may each count one or more particular types of memory accesses. Examples of such accesses include (but are not limited to) long duration accesses, accesses that are not speculative, and/or accesses that block execution of other instructions/

Event counters 208a-b may each include control logic to identify the occurrence of such events. This control logic may be implemented in any combination of hardware, software, and/or firmware. Event identification may occur based on the existence of corresponding interface (e.g., bus) signals and/or commands. Also, event identification may occur through from the execution of software instruction(s) associated with external device access, as well as through the existence of busy loops waiting for data. Embodiments, however, are not limited to these examples.

Thus, each of event counters 208a-b may generate a tally of such events that have occurred in a preceding (e.g., an immediately preceding) time interval. Various time interval durations may be employed. An exemplary duration is 1 millisecond. As shown in FIG. 2, event counter 208a provides its tally to control unit 204 as a count 220a, and event counter 208b provides its tally to control unit 204 as a count 220b. In embodiments, counts 220a-b may each be provided to control unit 204 through parallel (e.g., 16-bit) signal lines. However, other techniques may alternatively be employed.

Control unit 204 establishes performance characteristics for each of processor cores 202a-b based on their assessed operational efficiencies. As shown in FIG. 2, control unit 104 includes efficiency determination modules 210a-b, and a management module 212.

Efficiency determination modules 210a-b each determine an operating efficiency for a corresponding processor core. More particularly, efficiency determination module 210a determines an operating efficiency for processor core 202a, and efficiency determination module 210b determines an operating efficiency for processor core 202b. Each of these efficiencies may be determined based on the corresponding processor core's performance.

For instance, efficiency determination module 210a may determine an efficiency metric 222a from count 220a, and efficiency determination module 210b may determine an efficiency metric 222b from count 220b. Thus, in the manner described above with reference to FIG. 1, efficiency determination modules 210a-b may determine efficiency metrics 222a and 222b such that they are inversely proportional to counts 220a and 220b, respectively.

Management module 212 establishes operational characteristics of processor cores 202a-b. This may comprise establishing operating frequencies and/or voltages (e.g., P-states) for processor cores 202a-b. Alternatively or additionally, such characteristics may include clock toggling settings for processor core 102. Such operational characteristics of processor cores 202a-b may be established based on efficiency metrics 222a-b. Accordingly, FIG. 2 shows that management module 212 receives efficiency metric 222a-b from efficiency determination modules 210a-b.

Upon receipt of these efficiency metrics, management module 212 may select corresponding operational characteristics for each of processing cores 202a-b. For instance, management module 212 may send a directive 224a to processor core 202a, and a directive 224b to processor core 202b. These directives instruct processing core 202a-b to operate according to the operational characteristics selected for each of them.

As described above with reference to FIG. 1, the selection of operating characteristics for processor cores 202a-b may be in accordance with a scheme that maps ranges of efficiency metric 222a-b to particular operating characteristic(s). This mapping may be provided by a policy module 214. As shown in FIG. 2, policy module 214 may be included in management module 212. Also, policy module 214 may be implemented in the manner of policy module 114, as described above with reference to FIG. 1. Alternatively or additionally, management module 212 may perform coordination of operational characteristics for processor cores 202a and 202b. An example for coordination can be selecting single frequency and voltage to both cores 202a and 202b. Further, management modules 212 may perform various budget allocations. Such budget allocation techniques may include proportionally assigning operation conditions to each of processor cores 202a and 202b based on corresponding efficiency metrics 222a and 222b. However, other techniques may be employed. Thus, embodiments may advantageously balance power capacity among different components.

As described above, apparatus 200 may include a temperature sensor 216. This sensor determines a current operating temperature of apparatus 200. Temperature sensor 216 may be implemented in various ways. For example, temperature sensor 216 may include a thermistor-based circuit.

As shown in FIG. 2, temperature sensor 216 may provide management module 212 with a signal 225 that indicates the current operational temperature. Based on this signal, management module 212 may determine the amount of additional power consumption that apparatus 200 may handle without causing a maximum temperature to be exceeded. This additional power consumption is referred to as “headroom”.

Management module 212 may determine this additional headroom in various ways. In exemplary implementations, management module 212 may include a lookup table containing pre-stored headroom values for particular temperature values (or ranges of values).

Based on this headroom, management module 212 may determine limits for operational characteristic(s) for processor cores 202a-b, such as a maximum operating frequency and/or voltage (e.g., a P-state). Alternatively or additionally, clock toggling limits may be determined for processor cores 202a-b. Accordingly, in determining such characteristic(s) for directives 224a-b, policy module 214, may modify operational characteristic(s) determined from efficiency metrics 222a-b such that they do not cause the determined headroom to be exceeded.

In general operation, the embodiments of FIGS. 1 and 2 identify occurrences of inefficient processor operation due to external limitations (e.g., waiting on external device(s)). Thus, when such occurrences are identified, operational characteristic(s) may be selected that provide lower power consumption (and lesser performance). Such characteristic(s) may include an active mode state (e.g., a lower P-state). Alternatively or additionally, such characteristic(s) may include clock toggling characteristics for core 102 and/or cores 202a-b. Although providing less performance capacity, the selected characteristic(s) do not compromise actual performance. This is because additional performance capabilities are not needed at such times.

Conversely, when the occurrence of such inefficient operations decreases, operational characteristic(s) may be selected that cause higher power consumption (and greater performance). Such characteristic(s) may include an active mode state (e.g., a higher P-state). Alternatively or additionally, such characteristic(s) may include clock toggling characteristics for core 102 and/or cores 202a-b. Thus, through such techniques, power consumption may advantageously be conserved.

Moreover, embodiments may determine available headroom. Such determinations may be from temperature sensors. Accordingly, operational parameter(s) may be selected based on efficiency, and also to not exceed available headroom.

The features of FIGS. 1 and 2 may be implemented in any combination of hardware, software, and/or firmware. Moreover, although FIGS. 1 and 2 show processor cores that each have a single event counter, processor cores may include multiple event counters. In such implementations, multiple counters may count occurrences of different types of events. Thus, embodiments may determine efficiency metrics based on multiple counts.

Embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

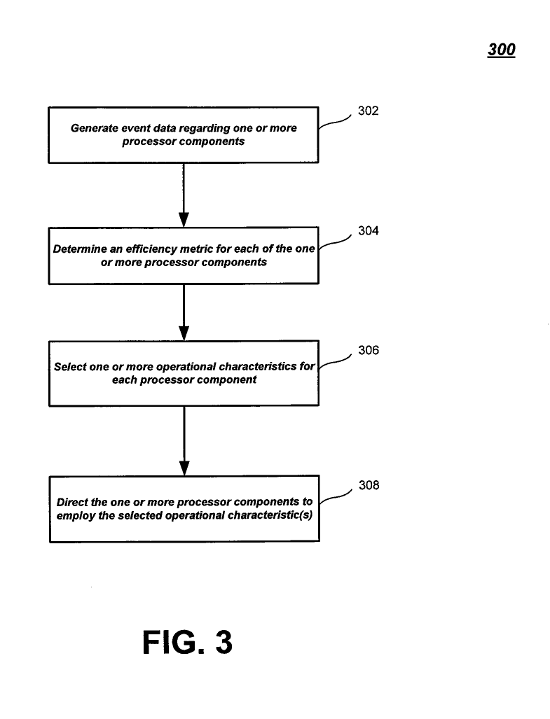

FIG. 3 is a diagram of an exemplary logic flow 300 involving the determination of operating characteristics based on efficiency. Although this diagram shows a particular sequence, other sequences may be employed. Also, the depicted operations may be performed in various parallel and/or sequential combinations.

As shown in FIG. 3, logic flow 300 includes a block 302 in which event data is generated regarding one or more processor components (e.g., one or more processor cores). For example, this may involve, for each processor component, determining a number of event occurrences in which the processor component awaits a response from a device.

At a block 304, efficiency metric(s) for the processing component(s) are determined from the event data. With reference to FIG. 1, this may involve the generation of efficiency metric 122 by efficiency determination module 110. Also, in the context of FIG. 2, this may involve the generation of efficiency metrics 222a and 222b by efficiency determination modules 210a and 210b, respectively.

Based on the efficiency metric(s), operational characteristics are selected for each processor component at a block 306. As described above with reference to FIGS. 1 and 2, such characteristics may include an operating frequency and/or voltage (e.g., a P-state) for each of the one or more processor components. Alternatively or additionally, such characteristics may include clock toggling settings for each of the one or more processor components. From such selection(s), the one or more processor components may be directed to employ the operational characteristics at a block 308.

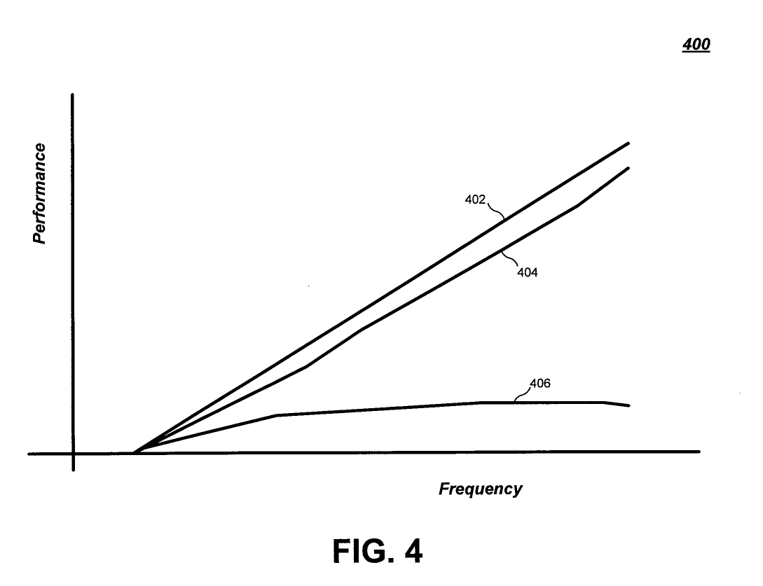

FIG. 4 is a graph 400 that includes plots of performance (e.g., speed) as a function of operating frequency. These plots are provided for purposes of illustration, and not limitation. For instance, graph 400 includes a plot 402 showing an ideal performance profile in which a processor's performance improves linearly as its operating frequency (and thus its power consumption increases). Similarly, a plot 404 shows a profile in which significant improvements in processor performance occur when the operating frequency is increased.

In contrast, a plot 406 shows a performance profile for a processor that is limited by external device(s). As described herein, this may involve a significant number of occurrences involving the processor waiting for responses from the external device(s). Thus, for plot 406, increases in frequency provide minimal (if any) improvements in performance. Thus, for this performance profile, it is not generally desirable to increase frequency. This is because significant additional power consumption is required to achieve small improvements in performance.

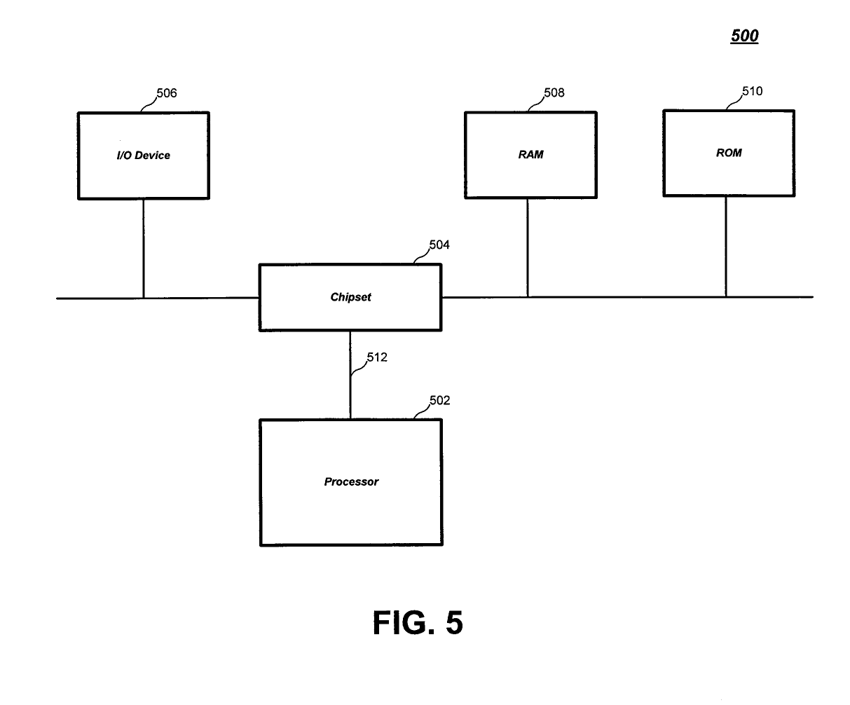

FIG. 5 is a diagram of an exemplary system embodiment. In particular, FIG. 5 is a diagram showing a system 500, which may include various elements. For instance, FIG. 5 shows that system 500 may include a processor 502, a chipset 504, an input/output (I/O) device 506, a random access memory (RAM) (such as dynamic RAM (DRAM)) 508, and a read only memory (ROM) 510. These elements may be implemented in hardware, software, firmware, or any combination thereof. The embodiments, however, are not limited to these elements.

As shown in FIG. 5, I/O device 506, RAM 508, and ROM 510 are coupled to processor 502 by way of chipset 504. Chipset 504 may be coupled to processor 502 by a bus 512. Accordingly, bus 512 may include multiple lines.

Processor 502 may be a central processing unit comprising one or more cores. Accordingly, processor 502 may enter into various operational states, such as one or more active mode P-states. Thus, processor 502 may include features described above with reference to FIGS. 1-3. For instance, processor 502 may include the elements of apparatus 100 and/or the elements of apparatus 200.

Therefore, in embodiments, operational characteristics of processor 504 (e.g., P-state(s)) may be established based on events in which it waits for responses from external devices. Examples of such external devices include (but are not limited to) chipset 504, I/O device 506, RAM 508, and ROM 510.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a counter to determine a number of event occurrences, wherein each of the event occurrences involves a processor component awaiting a response from a device;
an efficiency determination module to determine an efficiency metric based on the number of event occurrences; and
a management module to establish one or more operational characteristics for the processor component, the operational characteristics corresponding to the efficiency metric.

2. The apparatus of claim 1, wherein the one or more operational characteristics include a frequency and a voltage level.

3. The apparatus of claim 1, wherein the one or more operational characteristics include a P-state.

4. The apparatus of claim 1, wherein the number of event occurrences occur within a particular time interval.

5. The apparatus of claim 1, comprising a timer to measure a time interval, the management module to limit a number of operational characteristics established for the processor component within the time interval.

6. The apparatus of claim 1, further comprising a user preference interface to receive user preference information, the management module to establish the one or more operational characteristics for the processor component in accordance with the efficiency metric and the user preference information.

7. The apparatus of claim 1, wherein the event occurrences include one or more external memory communications or input/output communications.

8. The apparatus of claim 1, wherein the operational characteristics are coordinated between two or more modules.

9. The apparatus of claim 1, comprising a temperature sensor to provide the management module with a signal that indicates a current operational temperature, the management module to determine an available headroom based on the signal and establish the one or more operational characteristics based on the efficiency metric and on the available headroom.

10. The apparatus of claim 1, wherein the management module is to:
establish an increased operating frequency for the processor component when the efficiency metric indicates an increased efficiency of the processor component; and
establish a decreased operating frequency for the processor component when the efficiency metric indicates an decreased efficiency of the processor component.

11. A method, comprising:
determining an efficiency metric for a processor component;
selecting one or more operational characteristics for the processor component, wherein the one or more operational characteristics correspond to the efficiency metric

12. The method of claim 11, wherein selecting the one or more operational characteristics comprises selecting a P-state.

13. The method of claim 11, further comprising:
determining a number of event occurrences in which the processor component awaits a response from a device;
wherein the efficiency metric is based on the number of event occurrences.

14. The method of claim 11, wherein selecting the one or more operational characteristics comprises:
selecting an increased operating frequency for the processor component when the efficiency metric indicates an increased efficiency of the processor component; and
selecting a decreased operating frequency for the processor component when the efficiency metric indicates an decreased efficiency of the processor component.

15. The method of claim 11, wherein the event occurrences include one or more external memory communications or input/output communications.

16. The method of claim 11, wherein the efficiency metric is based on an application history for an application.

17. An apparatus, comprising:
two or more processor cores; and
a control module to determine operational characteristics for each of the two or more processor cores based on an operating efficiency for each of the two or more processor cores.

18. The apparatus of claim 17, wherein the determined operation characteristics includes an operating frequency or clock toggling for each of the two or more processor cores.

19. The apparatus of claim 17, wherein the control module is to determine each of the operating efficiencies based on a number of event occurrences in which the corresponding processing core awaits a response from a device.

20. The apparatus of claim 17, wherein the two or more processor cores and the control module are included in a central processing unit (CPU).
